(19) United States
(12) Patent Application Publication
(10) Pub. No.: US 2004/0145553 A1
(43) Pub. Date: Jul. 29, 2004

(54) Method for scanning sequence selection for displays

(76) Inventors: Leonardo Sala, Point St. Martin (IT); Daniele Domanin, Aosta (IT); Roberto Gariboldi, Lacchiarella (IT); Santo Ilardo, Leonforte (IT)

Correspondence Address: HOGAN & HARTSON LLP, ONE TABOR CENTER, SUITE 1500, 1200 SEVENTEENTH ST, DENVER, CO, 80202, US

(21) Appl. No.: 10/688,074

(22) Filed: Oct. 17, 2003

(30) Foreign Application Priority Data
Oct. 22, 2002 (EP) 02425638.0

(51) Int. Cl. G09G 3/36

(52) U.S. Cl. 345/87

(57) ABSTRACT

The present invention refers to a method for scanning sequence selection for displays. In one scanning sequence selection for displays having a plurality of rows and columns, the plurality of rows and columns cross each other defining a plurality of optical elements having a first optical state and a second optical state in response to a first electric state and to a second electric state. The method includes the phases of driving the plurality of rows of the display according to a prefixed scanning ordering. The prefixed scanning ordering is predisposed by ordering every column of the columns so that the total switching number between said first electric state and said second electric state is minimized.

### FIELD OF THE INVENTION

The present invention refers to a method for scanning sequence selection for displays.

### BACKGROUND OF THE INVENTION

An LCD display (Liquid Crystal Display) is generally formed by a matrix of row and column electrodes that, opportunely driven through the application of a voltage signal, define at the intersection points, the so-called pixels, a change of the optical behaviour of the interposed liquid crystal.

The driving of an LCD display through traditional technique requires that in correspondence of a unique selection pulse, applied to a certain row, the voltage values able to determine the turning on or the turning off of all the pixels of the excited row are applied on the column electrodes. The image on the display is completed in the moment in which the last row electrode has been selected. It is indicated with the word “frame” the lapse of time within which the complete scanning of the row electrodes multiplexed according to the just described principle, is completed. Such method is known as Alt & Pleshko (A&P), or, in its improved version, as Improved Alt & Pleshko (IA&P).

It is known nevertheless that the IA&P method sets some problems in the case of display with a great number of rows, because of the phenomenon called “frame response” and because of the great supply voltage required. To obviate to such drawbacks a technique called Multi-Line-Addressing (MLA) has been introduced in which a plurality of row electrodes is simultaneously selected through opportune orthonormal waveforms. Such a technique has been used in a great number of variations, that differ, for example, in the different temporal distribution of the excitement pulses or for the different grouping of the rows simultaneously selected.

### SUMMARY OF THE INVENTION

The Applicants have realized that all these variations are nevertheless joined by having a prefixed scanning ordering which is independent from the specific image that is intended to visualize. Besides, the current consumption of the driving devices is a function of the current required by the panel, which depends on the information pattern that is intended to visualize. At the varying of the information pattern, in fact, the charge that must be transferred to the panel varies, both for the switchings on the row electrodes (row) and for the switchings on the column electrodes (column). Therefore a consumption dependence of the panel, that visualizes a well defined information pattern, on the waveforms applied to the rows and on the waveforms applied to the columns exists.

In view of the state of the art described, an object of the present invention is to provide a method for the selection of the scanning sequence for displays, which has reduced consumes.

In accordance with the present invention, such object is reached by means of a method for scanning sequence selection for displays having a plurality of rows and columns, wherein said plurality of rows and columns cross each other defining a plurality of optical elements having a first optical state and a second optical state in response to a first electric state and to a second electric state, the method comprising the phases of driving said plurality of rows of said display according to a prefixed scanning ordering; characterized in that said prefixed scanning ordering is predisposed by ordering every column of said plurality of columns so that the total switching number between said first electric state and said second electric state is minimised.

Preferably, said prefixed scanning ordering is predisposed by ordering every column of said plurality of columns in such a way that, if the state change between the row i and the row j is different from the state change between the row i and the row i+1, then the scanning change is effected between the row i+1 and the row j. Advantageously, before effecting said ordering a further ordering is effected for every column of said plurality of columns by grouping the rows having the greatest number of said first electric state.

More advantageously, before effecting said ordering a further ordering is affected for every column of said plurality of columns by grouping the rows for number of presences of said first electric state.

Thanks to the present invention it is possible to realize a method for the selection of the scanning sequence for displays which is able to minimize the current consumptions, further to some undesired optical effects determined by the switchings of the driving waveforms, through the reduction of the switching number of the column signals, obtained through the determination of an optimal scanning ordering, built on the image that is intended to visualize.

### BRIEF DESCRIPTION OF THE DRAWINGS

The features and the advantages of the present invention will be made more evident by the following detailed description of a particular embodiment, illustrated as a non-limiting example in the annexed drawings, wherein:

FIG. 1 shows the time varying behaviour of the row and column signals in accordance to a first display driving method;

FIG. 2 shows the time varying behaviour of the row and column signals in accordance to a second display driving method;

FIG. 3 shows a flow chart relative to an ordering method for the scanning succession of the rows of a LCD display driven with the Alt&Pleshko technique, in accordance to the present invention;

FIG. 4 shows an image visualized by a display;

FIG. 5 shows a flow chart relative to a succession ordering method of the row scanning of a LCD display driven with the MLA technique, in accordance to the present invention;

FIG. 6 shows a block diagram of a circuit for the display control in accordance to the known art;

FIG. 7 shows a block diagram of a circuit for the display control in accordance to a first embodiment of the present invention;

FIG. 8 shows a block diagram of circuit for the display control in accordance with a second embodiment of the present invention.

### DETAILED DESCRIPTION

We now consider the driving technique known as Alt&Pleshko, together with its variations, that are characterized by the excitement of only one row of the display in every elementary instant of time. Starting from the simplest situation of a black and white display, it is observed that in the passage from the row N to the row N+1 the column waveforms can be subjected in general to assume a different voltage value. This happens, more precisely, if given the couple of pixel (Ri, Cj) and (Ri+1, Cj) where Ri identifies the row i and Cj identifies the column j, the state of such pixel is different. Under these conditions the voltage waveform of the column j will have a switching that allows considering such passage of state. Such switching determines a current consumption at electric level and a reduction of contrast at optical level, through a multiplicity of mechanisms.

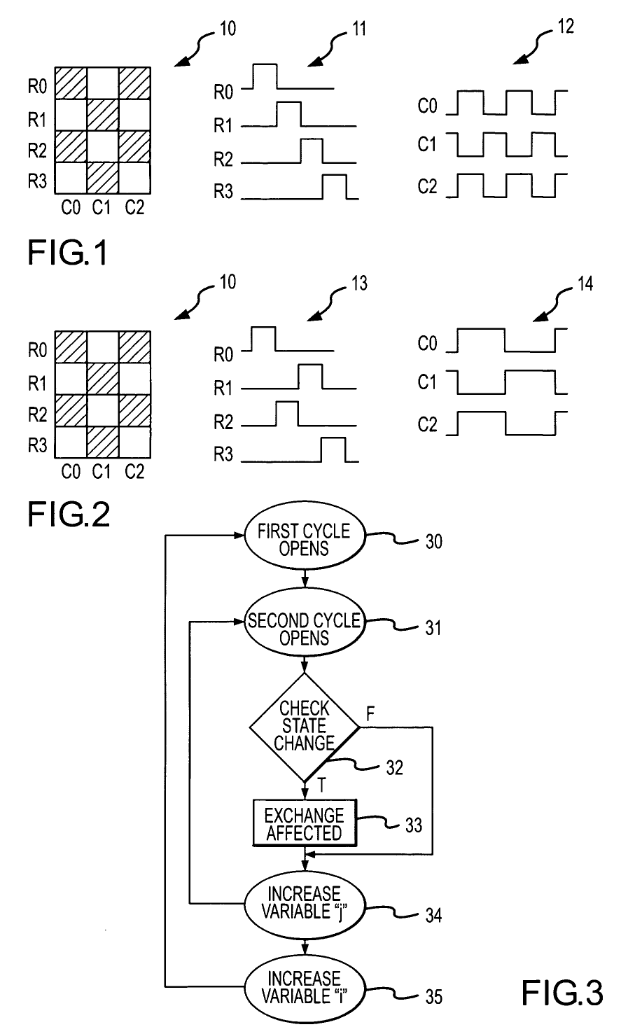

As it can be seen in FIG. 1, in order to visualize the image having the numerical reference 10 on a display having 4 rows and 3 columns, the rows R0-R3 must have a driving signal as reported in figure with the numerical reference 11, and the columns C0-R2 must have a driving signal as indicated in the figure with the numerical reference 12. In this first case there are four switchings of the column signal for every row, that is 12 switchings.

Instead, as it can be seen in FIG. 2, in order to visualize the same image having the numerical reference 10, the driving signal of the rows R0-R3 has been modified and reported in the figure with the numerical reference 13, and the driving signal of the columns C0-R2 has been modified accordingly and indicated in the figure with the numerical reference 14. In this second case there will be only two switchings of the column signal for every row, that is 6 switchings.

Supposing to have a display constituted by a single column, it could be possible to think about minimizing its switching number through the scanning of all the rows whose pixel is in the same state, followed by the scanning of all the rows in which the pixel is in the opposite state, whichever are the initial and final states, with an only intermediary switching, astride the two pixel groups. Since there is a plurality of rows in the display, at the varying of the image to be visualized, of course, it is not possible, in general, to reduce to 1 the switching number of all the columns; nevertheless it is possible to get the minimum number of switchings through an opportune ordering of the rows which considers the differences among the pixels of a given row and any other.

The method reported in FIG. 3 is proposed, that, given the number of total rows, requires n*(n−1)*(½) steps for the determination of the optimal ordering. The method produces as a result a vector, whose elements i are the indexes of the rows that it is necessary to excite in sequence to minimize the consumptions.

Referring now to FIG. 3, the ordering method of the scanning succession of the rows of a LCD display driven with the Alt&Pleshko technique will be described, in accordance to the present invention.

At the step 30 a first cycle opens, with variable i, that checks all the rows from the row 1 to the row n−2.

At the step 31 a second cycle opens, with variable j, that checks all the rows from the row 1+2 to the row n.

At the step 32 a check is effected to verify if the state change between the row i and the row j is different with respect to the change between the row i and the row i+1. In affirmative case T we proceed at the step 33, in negative case F we proceed to the step 34.

At the step 33 the exchange between the row i+1 and the row j is effected.

At the step 34 the variable j is increased and we proceed to the step 31. When the variable j has reached the value n we proceed with the step 35.

At the step 35 the variable i is increased and we proceed to the step 30.

The method described in accordance to a generic programming language is:

FOR i=1 TO n−2

FOR j=i+2 TO n

If Changes (i,j) <> Changes (i, i+1) THEN swaps (i+1, j)

NEXT j

NEXT i where “Changes (i,j)” means the state change between the row i and the row j, and “swaps (i+1,j)” means the exchange between the row i+1 and the row j.

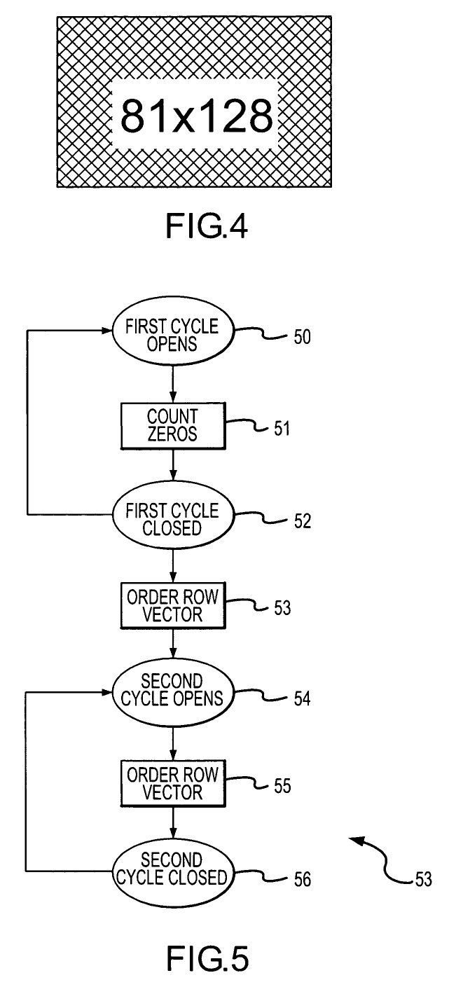

In the case of the image proposed in FIG. 4, for example, we change from a number of switchings equal to 6266, in the scanning for continuous rows, to a number of switchings equal to 422, with the optimal sequence, in accordance to the present invention.

In the case of more columns the operation of Changes (i,j) must be intended as state variation between the whole row i and the whole row j, or rather as calculation of the changes on all the columns of the two rows. In other terms a comparison between the two rows is globally effected.

In the case of MLA technique, the problem is set in more complex terms for the fact that before establishing what ordering the groups of rows simultaneously excited must follow, it is necessary to establish as these quatrains are composed, or what rows must be selected for being excited together. Particularly, a solution is provided for the so-called “Distribuited MLA”, in which the p pulses associated to a single row (having indicated with p the row number simultaneously selected) are equispaced in the time, as this is the solution that allows to best solve the problem of the frame response. With the MLA technique, the waveform of column does not assume a certain value in function of the state of a single pixel, but in function of the state of more pixels; particularly, the voltage value resulting for the waveform of the column electrode is determined by the calculation of the number of different bits among the so-called “row pattern” (given by the state of the four row voltages applied to the four rows simultaneously selected) and the so-called “information pattern”, that is the vector of four pixels that lie at the intersection between a given column and the four selected rows.

A first immediate extension of the algorithm previously described for the A&P technique is possible by ordering in accordance to the preceding method the row signals, and applying, in succession, the p simultaneous selection pulses to the p rows, that is to the p rows defined by adjoining vector indexes, for example, in the typical case of using 4 simultaneously driven rows (p=4), by exciting together the rows pointed by the positions from 1 to 4 of the vector previous ordered for differences, then proceeding with the rows from 5 to 8 and so on.

This way of proceeding has got a meaning because, if the objective is that to have excited in succession on each column groups of 4 pixels (belonging to the same row number) which are maximally similar, so that compared to the same row pattern the difference, and therefore the voltage, is also maximally similar, then the ordering for differences before described tends really to make rows closer, considered also in groups of 4, besides to 2 by 2, which are still very similar, although the described method can be improved.

Nevertheless, it is possible to improve the method before described, by preceding the ordering for differences among adjoining rows (or rather the method previously described) with an ordering for equal number of bits on each single row separately. The first part of the method consists in fact in ordering (in increasing or decreasing ordering, indifferently) for number of present zeros (or ones).

In forming a scanning row quatrain we refer to a n-row belonging to the first quarter of this orderly set, to a n-row of the second quarter and so on, at the end the information patterns will be distributed in such a way that all of them have a number of 1/0 very similar for construction, even if it is not known where such 1/0 are.

The second part of the method consists in an ordering for differences (or state changes), as the one previously proposed, but which acts in an independent way in the four sections in which the ordered list of the rows for equal bit number will be divided.

At this point, there are taken the first row of each of the p-sections (constituting the first group of p-rows simultaneously selected) in which the list has been divided, the second of each p-section and so on, up to complete the first frame quarter (after N/p groups of selected rows), then repeating other p−1 scanning up to complete the whole frame.

This new method is schematised in FIG. 5.

At the step 50 a first cycle opens scanning all the rows.

At the step 51 the number of the 0 present in each row is counted.

At the step 52 the first cycle is closed.

At the step 53 the row vector is ordered (in increasing or decreasing ordering, indifferently) for the number of present zeros. The ordering method can be anyone known to the technician of the field.

At the step 54 a second cycle opens scanning all the rows.

At the step 55 the method before described is applied, that is the vector of the rows ordered at the step 53 is now ordered so as to reduce the switching number between a row and the other.

At the step 56 the second cycle is closed.

With the ordering for zero numbers we have that in each quatrain (in the case of p=4), altogether the number of 1/0 is maximally similar, and with the ordering for differences it is guaranteed that in every instant of time the selected row in the group i (1<i<p) has a minimum number of switchings in comparison to the preceding one (preceding instant) of the same group.

The computational cost that involves the ordering for zeros numbers is function of the type of method of ordering used; it can vary from the n(n−1)/2 steps for the ordering method defined “bubblesort” to the n*log2(n) steps of the ordering method defined “quicksort”. The ordering for differences instead involves a computational complexity with a number of steps equal to (n/p)*(n/p−1)*(p/2).

In function of the row number of the display and the refreshment frequency of the images, in order to effect the comparisons among the rows it can be enough to lean to the normal mechanism for reading the memory RAM during the visualization of its content or an independent reading and comparison mechanism can be predisposed that accelerates the ordering process and therefore increases the current saving through the rapid individualization of the minimum consumption configuration.

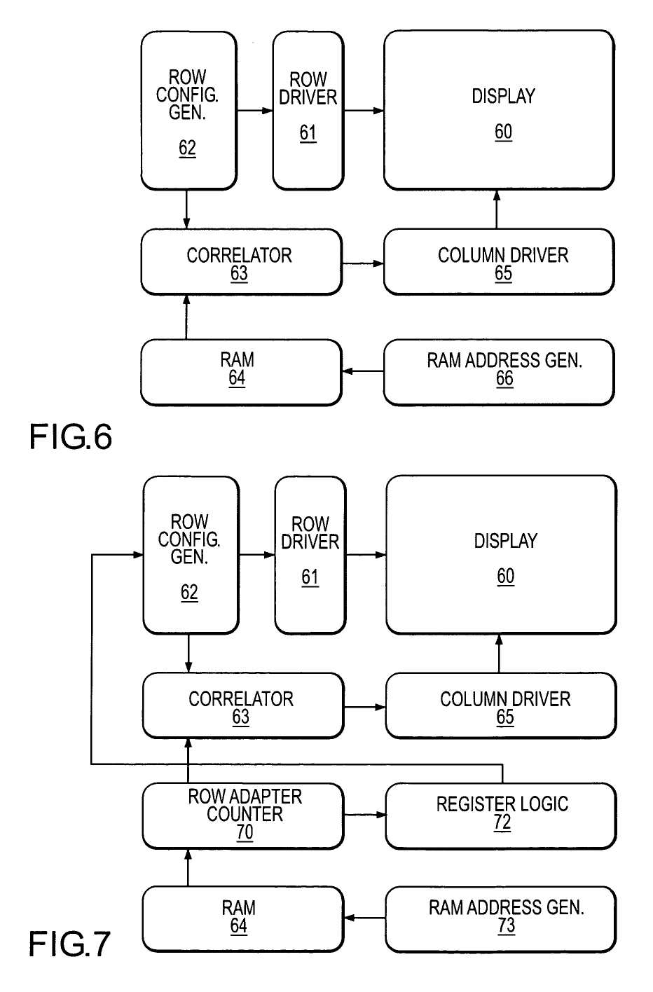

We refer now to FIG. 6 that shows a block scheme of a control circuit of a display in accordance to the known art.

In this figure the architecture of a typical LCD controller is reassumed, valid both in the case of driving in accordance to the A&P technique, and in the case of driving in accordance to the MLA technique, from the moment that the A&P technique can be considered as a degenerate case of the MLA technique, obtained with a row number simultaneously driven equal to 1.

It includes a display 60 that receives the driving signals from a row driving stage 61 and a column driving stage 65.

A RAM memory 64, whose output is applied to a correlator 63, is used for the storing (buffer memory) of the information to be visualized, and it allows the reduction of the data flow that the microcontrollor (not shown) sends to the LCD controller through maintenance of a local copy.

A row configuration generator 62 defines the row waveforms, proposing it in coherent form both to the row driving stage 61 and to the correlator 63 through which the column waveforms will be calculated.

The correlator 63, that receives data from the row configuration generator 62 and from the RAM 64, furnishes data to the column driving stage 65. The correlator 63 allows to value, during the p refreshment scannings of the LCD display associated to the presence of p rows simultaneously selected, the appropriated column voltage value. In geometric terms, this block values the orthogonal projection of the column waveform on one of the p row functions that constitute a complete base of the space of the column waveforms. The typical realization of this block at circuital level foresees, for a generic column Cj, the calculation of the bit-to-bit differences among p bits of information (extracted by the RAM 64 on the cells of the column j on the p rows selected in a certain instant) and the p bits descriptive of the row waveform applied in the same instant to the p selected rows. In the degenerate case of driving in A&P, the complete orthonormal base of the row waveforms is constituted by identically null functions except that in an only instant, correspondent to that of activation of the selected row.

The row driving stage 61 receives data from the row configuration generator 62 and furnishes its output data to the display 60. The row driving stage 61 effects the association among the descriptive binary code of the row configuration in a certain instant and the corresponding voltages, besides the conditioning of the necessary signal to guarantee an output impedance sufficiently reduced, so as to limit the deformation of the waveform applied to the display.

The column driving stage 65 effects the association among the descriptive binary code of the column configuration in a certain instant and the corresponding voltages, besides the conditioning of the necessary signal to guarantee an output impedance sufficiently reduced, so as to limit the deformation of the waveform applied to the display.

A RAM address generator 66 produces the access addresses in RAM 64 in progressive reading, or a simple counter to fix the ordering of access to the RAM 64.

Referring now to FIG. 7 that shows a block scheme of a display control circuit in accordance to a first embodiment of the present invention. The blocks similar to those of FIG. 6 have the same numerical reference.

In the method previously described takes place, in every instant, the evaluation of the number of bits that change among a reference row “i” (already placed in the correct ordering in comparison to the preceding ones) and the following “i+1” (that is the more closest to the row “i” found up to now) and the evaluation of the bit number that change among the same reference row “i” and the next “j” candidate to be the row that follows “i”, for the fact to be very similar.

Therefore, in FIG. 7 we find a generation block 73 of the evaluation addresses that has really the purpose to generate all the pairs of necessary rows to give a complete evaluation of the scanning ordering which is in absolute the best for a globally minimum number of differences among all the articulated rows. If we suppose that the ordering occurs “off- line”, or if among the end of a scanning frame of the display 60 and the beginning of the following one the necessary time to complete the ordering will be available, this block can complete the aforesaid ordering, through the access in RAM 64, dictated not by the demand to bring the information to the display 60, but by the demand to complete the ordering.

In FIG. 7 we find a row adapter counter 70, that receives data from the RAM 64 and furnishes data to the correlator 63 and to a register logic 72. The row adapter counter 70 consists of a couple of registers, able to determine the number of differences among the row i firmly memorised in a register and the row j saved in the other register. At each following comparison between i and j, if the adaptation degree is greater than the excellent one previously found, then in the register logic 72 the pointer is adjourned to the next row (i+1), in such a way that it points to the previous row in the position j. In the register logic 72 the pointer is updated to the row j, now promoted to i+1, saving the previously row in the position i+1 (that is a swap is made). It is saved in the register logic 72 the new minimum difference among the row i and the i+1(ex j), that will constitute the new reference for the following comparisons.

The register logic 72 is therefore the block that allows “to annotate” at the algorithm progress the new ordering of the rows and the set variable necessary to the completion of the same method, or the state of the ordering vector of the rows. The register logic 72 receives data from the row adapter counter 70 and furnishes data to the row configuration generator 62.

At the completion of the ordering phase, it will be the same register logic 72 to determine the real scanning ordering of the display 60 by making reference to the complete version of the row ordering vector.

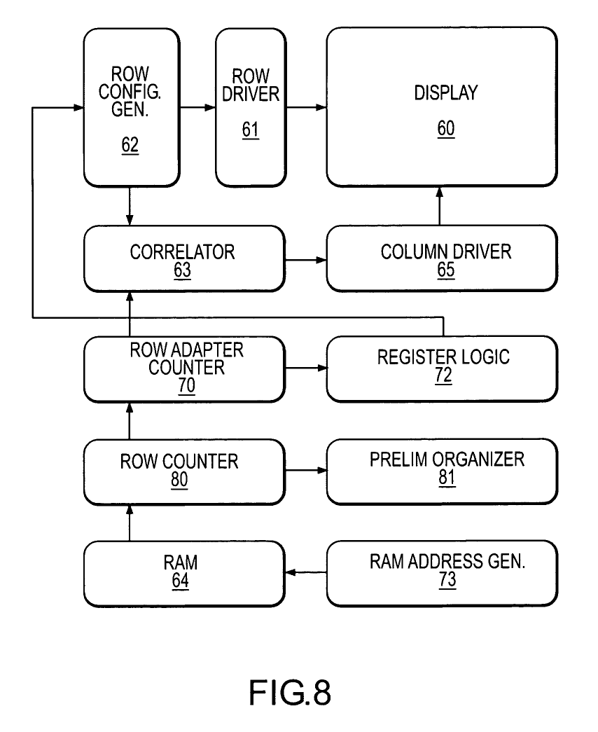

We refer now to FIG. 8 that shows a block scheme of a display control circuit in accordance to a second embodiment of the present invention. The blocks similar to those of FIG. 7 have the same numerical reference.

In FIG. 8 we find a row counter 80 having value 0, that receives the data from the RAM 64 and furnishes data to the row adapter counter 70 and to a preliminary organizer 81, which furnishes data to the register logic 72. These two blocks allow to obtain the ordering for numbers of zeros.

Having described and illustrated the principle of the invention in a preferred embodiment thereof, it is appreciated by those having skill in the art that the invention can be modified in arrangement and detail without departing from such principles. I therefore claim all modifications and variations coming within the spirit and scope of the following claims.

1. A method of scanning sequence selection for displays having a plurality of rows and columns, wherein said plurality of rows and columns cross each other defining a plurality of optical elements having a first optical state and a second optical state in response to a first electric state and to a second electric state, the method comprising:
driving said plurality of rows of said display according to a prefixed scanning ordering; and
ordering every column of said plurality of columns so that the total switching number between said first electric state and said second electric state is minimized.

2. The method according to claim 1 wherein said prefixed scanning ordering comprises ordering every column of said plurality of columns so that, if the state change between row “i” and row “j” is different from the state change between row “i” and row “i+1”, then the scanning change is effected between row “i+1” and row “j”.

3. The method according to claim 1 further comprising an ordering for every column of said plurality of columns by grouping the rows having the greatest number of said first electric state.

4. The method according to claim 1 further comprising an ordering for every column of said plurality of columns by grouping the rows having the greatest number of said second electric state.
